(19) United States
(12) Patent Application Publication
(10) Pub. No.: US 2007/0203015 A1
(43) Pub. Date: Aug. 30, 2007

(54) Ceramic dielectrics for base-metal-electrode multilayered ceramic capacitors and the preparation thereof

(75) Inventors: Wei-Hsing Tuan, Taipei (TW); Yung-Ching Huang, Taipei (TW)

Correspondence Address: BIRCH STEWART KOLASCH & BIRCH, PO BOX 747, FALLS CHURCH, VA, 22040-0747, US

(73) Assignee: National Taiwan University

(21) Appl. No.: 11/709,195

(22) Filed: Feb. 22, 2007

(30) Foreign Application Priority Data
Feb. 24, 2006 (TW) 095106219
Oct. 17, 2006 (TW) 095138142

(51) Int. Cl. C04B 35/00; B32B 15/04

(52) U.S. Cl. 501/137; 428/469; 428/472

(57) ABSTRACT

The present invention discloses a new dielectric material can be used as the dielectric for base-metal electrode multilayer ceramic capacitors. In the present invention, a small amount of fine metallic particles are added into barium titanate based powder. The metallic particles can absorb oxygen to prevent the oxidation of the internal electrode. The metal is then oxidized to result in an oxide that can dissolve into the dielectric. The dielectric material of the present invention can be co-fired with nickel or copper internal electrode in a sintering atmosphere of commercial nitrogen or even of air. After sintering, no post-sintering heat treatment is needed.

### BACKGROUND OF THE INVENTION

1. Field of the Invention

The present invention discloses a dielectric material for base-metal electrode multilayer ceramic capacitors (BME-MLCC). In the dielectric, a small amount of fine metallic particles distributed uniformly within the ceramic particles. As the dielectric and the internal electrode are co-fired together, the fine metallic particles can act as oxygen getter to prevent the oxidation of the internal electrode. After the metallic particles are oxidized, the metallic oxide particles can dissolve into the dielectric. The dielectric disclosed in the present invention exhibits excellent oxidation resistance and it can thus be co-fired with the internal electrode, such as nickel or copper, in industrial nitrogen or in air. The post-sintering annealing process is usually needed for production of conventional BME-MLCC. However, such treatment is no longer needed as the dielectric disclosed in the present invention is used.

2. Description of Related Art

Barium titanate based materials have been frequently used the dielectric in ceramic capacitors for their high permittivity. In the last two decades, the electronic components are reduced significantly in size. To match the trend, the ceramic capacitor has also changed from single layer to multi-layer to increase its volume efficiency. Silver-palladium (Ag—Pd) electrode has been used as the internal electrode material in the beginning for its excellent oxidation resistance. However, the price of palladium is high and varied from time to time. The based metals, such as nickel and copper, are therefore used to replace Ag—Pd electrode.

For the case of nickel electrode capacitor, metallic nickel will be oxidized as the oxygen partial pressure within the sintering atmosphere is higher than 10⁻⁹ atm. The nickel oxide is no electrical conducting. The base metal electrodes have therefore to be co-fired with the dielectrics in an atmosphere with low oxygen partial pressure. However, many free electrons may be generated as the barium titanate based materials are fired in an atmosphere with low oxygen partial pressure. The insulation resistance of the barium titanate dielectrics thus decreases significantly after sintering in a atmosphere with low oxygen partial pressure. Such materials can no longer be used as the dielectrics for capacitors.

Since 1980, the research on the development of using base metals as the internal electrode for ceramic capacitors has started. The major concern is the development of a dielectric which is still electrical insulator (or resistant to reduction) as it is fired at low oxygen partial pressure atmosphere. There are many additives have been used to replace Ba or Ti in BaTiO₃ in order improve the reduction resistance. For example, Mg and Ca have been used to replace Ba, and Zr to replace Ti, and Mn to replace some Ba and some Ti. Apart from these additives, some rear-earth element oxides, La₂O₃, Sm₂O₃, Dy₂O₃, Ho₂O₃, Y₂O₃, Er₂O₃, Yb₂O₃, have also been used to improve the reduction resistance. These rear-earth metallic ions can either replace Ba or Ti. The oxygen vacancy concentration is also increased as the ceramic dielectric is sintered in an atmosphere with low oxygen partial pressure. The increase of the oxygen partial reduces the reliability of the capacitors for long-term usage.

Though many additives are used to improve the reduction resistance of BaTiO₃ based dielectrics, there are still too many oxygen vacancies existed after firing in the low oxygen partial pressure atmosphere. To solve the problems, an annealing treatment is needed. The annealing treatment temperature is about 200 to 300 degree lower than that of sintering temperature, the oxygen partial pressure is about 10² to 10³ higher than that in the sintering atmosphere. Due to the oxygen partial pressure during annealing is higher than sintering atmosphere, the oxygen vacancy in the BaTiO₃ based material is decreased. The reliability of the base metal electrode capacitor can also be improved.

The current status of the technology used to manufacture base metal electrode multilayer ceramic capacitor can be summarized in the following. To avoid the oxidation of internal electrodes, such as nickel or copper, the oxygen partial pressure in the sintering atmosphere has to be lower than a certain value. To reduce the free electron induced by the low oxygen partial pressure, many ceramic additives are used to act as the acceptors to BaTiO₃. To improve the reliability of the BME MLCC, many rear-earth oxides are used as the additives. Furthermore, a post-sintering annealing treatment is needed. Though the annealing temperature is lower than that of sintering, the oxygen partial pressure during annealing is higher than that in the sintering atmosphere. The oxygen vacancy is reduced after the annealing treatment, the reliability of the BME-MLCC is therefore high.

Though the BME-MLCCs have been available from market for quite come time already. There are two issues to be solved. First, the price of the rear-earth oxides is high, the cost of the dielectric for the BME-MLCC remains high. Second, the oxygen partial pressure within the sintering atmosphere has to be controlled tightly. Such sintering furnace is therefore expensive. Furthermore, an annealing furnace with delicate sensors to monitor the oxygen partial pressure is also needed. The time for the annealing treatment has to be long enough to ensure the reduction of oxygen vacancy. However, such extra treatment attracts additional manufacturing cost to the BME-MLCC. Therefore, the cost of BME-MLCC is therefore high.

### SUMMARY OF THE INVENTION

The present invention discloses a new formula for the dielectric of BME-MLCC. The new dielectric powder composes of ceramic dielectric powders and at least one metallic powder. The chemical activity of the metal powders to oxygen is higher than that of the internal electrode to oxygen. During sintering, the metal particles can attract the oxygen from the surrounding atmosphere to prevent the oxidation of the internal electrode. Therefore, the dielectrics disclosed in the present invention can be sintered in an atmosphere with a relatively high oxygen partial pressure. For examples, the dielectrics disclosed in the present invention can be fired in commercial nitrogen or even in air. Since the oxygen partial pressure during sintering is relatively high, the oxygen vacancy after sintering is thus low. The post-sintering annealing can therefore be omitted. Therefore, the present invention can reduce the steps used to manufacture BME-MLCC. Furthermore, the sintering can be carried out within an atmosphere of relatively high oxygen partial pressure. The requirement on the tight control of the oxygen partial pressure during sintering is relaxed. The price for such sintering furnace can also be reduced significantly.

The present invention also discloses the method to prepare the dielectric material. The dielectric material can be used as the ceramic dielectric for the BME-MLCC. The method is started with the mixing of nickel salt solution and the normal dielectric powder for ceramic capacitor. The solution is milled with the ceramic powder then dried. The dried powder is then calcined to decompose the salt to result in nickel oxide. The nickel oxide can then be reduced in a reducing atmosphere to result in fine metallic nickel particles. After the reduction process, the fine nickel particles distributed uniformly within the ceramic dielectric powder.

The present invention also discloses the method of using the previous mentioned powder to manufacture ceramic BME-MLCC. The previous mentioned powder can be co-fired with the inner electrodes, such as nickel, to produce BME-MLCC. There are fine metallic particles distributed uniformly within the ceramic particles. The size of the metallic particles is smaller than that of the metallic particles used in the inner electrode. The fine particles within the ceramic dielectric can thus attracted all the nearby oxygen to prevent the oxidation of the inner electrode. The BME-MLCC can thus sintered in an atmosphere with a higher oxygen partial pressure. For the same reason, the annealing treatment frequently used for the conventional BME-MLCC is no longer needed. The production cost of manufacturing the BME-MLCC of using the dielectric disclosed in the present invention is expected to be lower.

### BRIEF DESCRIPTION OF THE DRAWINGS

FIG. 1A is a TEM micrograph of the BaTiO₃ particles.

FIG. 1B is the particle size distribution of the BaTiO₃ particles.

FIG. 2 is a TEM micrograph of the nickel-coated BaTiO₃ particles. The fine particles on the surface of the large particles are nickel.

FIG. 3 is an XRD pattern of the nickel-containing dielectric powder after reduction treatment.

FIG. 4 is the dielectric constant of the nickel-containing dielectric after sintering as a function of nickel content.

FIG. 5 is the dielectric loss of the nickel-containing dielectric after sintering as a function of nickel content.

FIG. 6 is the electrical resistivity of the nickel-containing dielectric after sintering as a function of nickel content.

FIG. 7 is an XRD pattern of the nickel-containing dielectric after sintering.

FIG. 8 is a schematic of the sandwich specimens as the specimens used in Example 8.

### DESCRIPTION OF THE INVENTION

The present invention discloses a new dielectric. The dielectric can be used as the ceramic for the BME-MLCC. Within the new dielectric, ceramic dielectric and fine metallic particles are mixed uniformly together. The ability of the metallic particle of absorbing oxygen is higher that of the inner electrode materials. The presence of such fine metallic particles can thus protect the inner electrode from oxidation during sintering.

The dielectric powder discloses in the present invention is used as the ceramic for the BME-MLCC. The major ingredient of the dielectric is barium titanate, strontium titanate, zinc titantate etc. Apart from these ceramic powders, fine metallic particles are distributed uniformly on the surface of the ceramic powders.

The dielectric discloses in the present invention can be easily used as the ceramic for BME-MLCC. The major component is the same as those used for the conventional BME-MLCC ceramic materials, which are barium titanate, strontium titanate, zinc titanate etc. However, the present invention can be applied to any ceramic dielectric that is used for ceramic capacitors. The above truth is supported by the experimental results of our studies. Therefore, the present invention can be applied as the ceramic powders for all ceramic capacitors.

For the conventional dielectric used in the current BME-MLCC, several oxides and rear-earth oxides are frequently added. The addition of fine metallic particles can also improve the oxidation resistance of the ceramic dielectric. Therefore, the addition of several oxides and several rear-earth oxides affect little to the effectiveness of the dielectric powder discloses in the present invention.

Silver-palladium alloy is still used as the inner electrode for the conventional multilayer ceramic capacitor (MLCC). The MLCC with the Ag—Pd as the inner electrode can be sintered at elevated temperature in air. The Ag—Pd alloy is still electrical conducting after firing in air. The requirement on the kiln used to fire the MLCC is thus relatively simple. As long as the temperature uniformity can be achieved, the atmosphere control is not critical at all. Nevertheless, the cost of the precious metal, Pd, is high. The cost of the MLCC containing such precious metal as inner electrode is also high. The dielectric disclosed in the present invention can be used as the dielectric for BME-MLCC. The inner electrode for the BME-MLCC can be nickel or copper. In the moment, nickel is frequently used as the inner electrode for the BME-MLCC. The inner nickel electrode is composing of metallic nickel particles and organic binders. The size of the nickel particles is usually smaller than 1 micrometer. For the most case, the size of the nickel particles in the starting inner electrode varies from 0.2 to 0.6 micrometer.

The dielectric disclosed in the present invention contains fine metallic particles. The chemical activity of the fine metallic particles is higher than that of the metallic particles in the inner electrode. The fine metallic particles are therefore more active to oxygen than that of the metallic particles within the inner electrode. The fine metallic particles can thus compete with the metallic inner electrode to absorb available oxygen to form metallic oxide. The metals used in the present invention can also be the same as the metals used in the inner electrode. As long as the size of the metallic particles is smaller than that of the metallic particles within the inner electrode, the chemical activity of the fine metallic particles is higher than that of the metallic particles within the inner electrode. The nearby oxygen can thus be attracted to the fine metallic particles instead of to the inner electrode. The inner electrode is therefore well protected from oxidation by the presence of such nearby fine metallic particles. For the case that the metal in the dielectric disclosed in the present invention is the same as that in the inner electrode, the size of the metallic particles should be smaller than the size of the metallic particles used in the inner electrode. The particle size of the fine metallic particles disclosed in the present invention is smaller than 0.6 micrometer.

The fine metallic particles used to add into the ceramic dielectric powder disclosed in the present invention can be nickel, titanium, manganese, copper or their mixtures or their alloys. The presence of nickel oxide can prohibit the grain growth of barium titanate based materials. The copper oxide can form a liquid phase to enhance the densification of barium titanate based materials. Therefore, the metals used in the present invention can be nickel, titanium, manganese, copper, their mixtures or/and their alloys. To be demonstrated later, the amount of the metal phase in the dielectric disclosed in the present invention varies from 0.001% to 10 wt %. The most suitable amount varies from 0.1% to 5 wt %.

The method which can be used to prepare to the dielectric is also disclosed in the present invention. The method is started with the mixing of the salt solution of nickel or copper with barium titanate based ceramic powder. The slurry is then dried to remove the solvent. The calcination treatment is then used to decompose the salt to result in metallic oxides, such as nickel oxide or copper oxide. The powder mixtures of barium titanate based ceramic and metallic oxides are then reduced in a highly reducing atmosphere. The metallic oxides can then reduce to result in fine metallic particles. The fine metallic particles distribute uniformly within the barium titanate based particles.

The processing comprising the following steps:
(a) The nickel or copper salts are dissolved in a solvent or water to form a solution. (b) The ceramic dielectric powder is then added slowly into the solution. The slurry is then ball milled for several hours.
(c) The slurry is then dried to remove the solvent. The dried lumps are then crushed to result in powder mixtures.
(d) The powder mixtures are calcined at an elevated temperature to thermal decompose the salts. The metals can also be oxidized to form nickel oxide or copper oxide.
(e) The powder mixtures are then reduced in a reducing atmosphere to reduce the metallic oxide to result in nickel or copper. The nickel or copper particles are existed uniformly within the ceramic dielectric particles.

By using the metallic salts to start with, it is due to that the metallic ion can be formed in the slurry as the salts are dissolved in solvent. The ions in the solution can adsorbed onto the surface pf the ceramic dielectric particles. Therefore, the metallic ions can distribute uniformly onto the surface of every dielectric particles. The salts can be nitrates, carbonates, hydroxides, citrates etc. These salts can be dissolved into water, ethyl alcohol and other solvents. The higher solubility of the salt in the solvent is preferred, it is due to that the solvent to be removed in the later step is decreased as the solubility is high. Among the salts mentioned above, the solubility of the metallic nitrates in either water or in ethyl alcohol is usually high.

The reducing atmosphere can be used to reduce the metallic oxide particles into fine metallic particles is H₂ or the gas mixtures of 90% N₂ and 10% H₂.

The dielectric disclosed in the present invention can be used as the dielectric for the base-metal electrode multilayer ceramic capacitor (BME-MLCC). The ceramic powder in the dielectric can be barium titanate, strontium titanate or zinc titanate. The metal of the inner electrode for the BME-MLCC is either nickel or copper.

The dielectric disclosed in the present invention can be fired with the base-metal inner electrode in an atmosphere with relatively high oxygen partial pressure. Our experimental results demonstrated that the dielectric disclosed in the present invention could be fired with the inner electrode in an atmosphere of 10⁻⁹ atm oxygen partial pressure. Satisfactory results can also be obtained by co-firing the dielectric with the inner electrode with an atmosphere of 10⁻⁴ atm oxygen partial pressure. The oxygen partial pressure in the commercial nitrogen is around 10⁻⁴ atm. It thus suggests that the dielectric disclosed in the present invention can be co-fired with the inner electrode in commercial nitrogen. The cost of the commercial nitrogen is relatively low. Furthermore, due to the BME-MLCC with the dielectric disclosed in the present invention can be sintered in an atmosphere with relatively high oxygen partial pressure. The oxygen vacancy concentration in the dielectric after sintering is low. The annealing treatment which is usually used for the manufacturing conventional BME-MLCC is no longer needed. Therefore, the manufacturing cost of the BME-MLCC with the dielectric disclosed in the present invention can be low. In the present invention, the co-firing of the dielectric and inner electrode in air is also possible.

The dielectric disclosed in the present invention can be co-fired with the inner electrode in an atmosphere of 10⁻⁹ atm and above 10⁻⁴ atm oxygen partial pressure.

The following examples demonstrated the objective, preparation method and benefits of the present invention.

### EXAMPLE 1

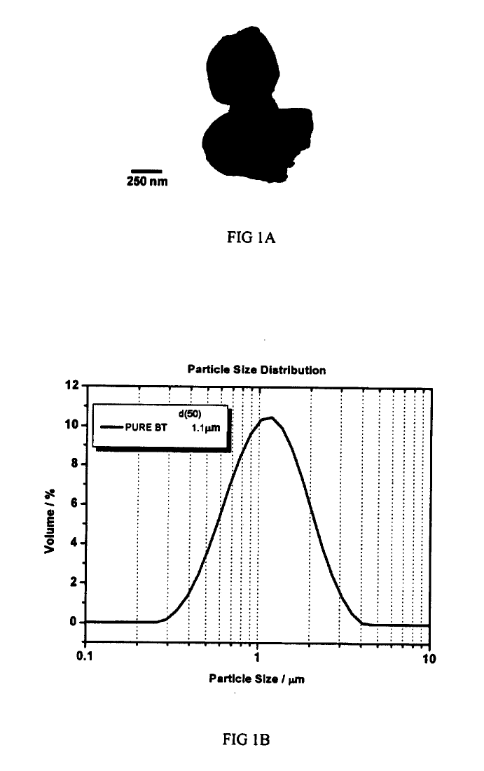

(a) A barium titanate powder (BaTiO₃>99%, NEB, Ferro Co. USA, ˜1 micrometer) was milled in PE jar for 4 hours in a turbo mill. The grinding media were zirconia balls, the solvent was ethyl alcohol. The morphology of the barium titanate particles after milling is shown in FIG. 1A. The average particle size of the barium titanate particles is 1.1 micrometer, shown in FIG. 1B.
(b) The slurry was dried in a vacuum dryer. The dried lumps were furthered dried in an oven at 10° C. for 24 hours.
(c) The dried powder was crushed by mortar and pestle, and then sieved with a #150 sieve. The powder compact with the diameter of 10 mm was formed by uniaxial pressing at 20 MPa.
(d) Sintering was carried out at 1330 C for 2 hours in a box furnace in air. The heating and cooling rates were 3 C/min.
(e) After sintering the surface of the sintered discs were slightly ground with SiC sand papers. A silver paste (Ferro, Product No. TK33-008LV, Ferro Co., USA) was applied on the surface as the electrode. The firing for the Ag electrode was performed at 600 C for 1 hour. The heating and cooling rates were 5 C/min.
(f) The electrical properties of the barium titanate discs were measured with a LCR meter and high-resistance meter. The dielectric constant of the barium titanate specimen was 3100, the dielectric loss (or dissipation factor) was 1.1% and the electrical resistivity was 5×10¹⁴ ohm-cm.

The present example demonstrates that the barium titanate used in the present Example can be used as the dielectric for the capacitor.

### EXAMPLE 2

The preparation steps for the BaTiO₃ specimens shown in the present example are the same as those described in the Example 1, except that the specimens were sintered in a commercial nitrogen atmosphere. The oxygen partial pressure within the nitrogen was 10⁻⁴⁻⁵ atm as determined by a zirconia oxygen sensor, which located above the specimens during sintering. The sintering was performed at 1330 C for 2 hours. The electrical properties of the BaTiO₃ specimens are: dielectric constant 23500, dielectric loss 9.4%, electrical resistivity 9×10⁵ ohm-cm.

The electrical resistivity of the BaTiO₃ specimens is rather low. It demonstrates that the BaTiO₃ specimen sintered in the commercial nitrogen is no longer an electrical insulator. The BaTiO₃ specimen can not be sintered in commercial nitrogen.

### EXAMPLE 3

The preparation steps for the BaTiO₃ specimens shown in the present example are the same as those described in the Example 1, except that the BaTiO₃ specimens were sintered in a 90% N₂/10% H₂ atmosphere. The oxygen partial pressure within the atmosphere was as low as only 10⁻¹²⁻¹³ atm as determined by a zirconia oxygen sensor, which located above the specimens during sintering. The sintering was performed at 1330 C for 2 hours. The electrical properties of the BaTiO₃ specimens are: dielectric constant 84680, dielectric loss 11.9%, and electrical resistivity 5×10⁶ ohm-cm.

The electrical resistivity of the BaTiO₃ specimens is also very low. It demonstrates that the BaTiO₃ specimen sintered in the atmosphere of the oxygen partial pressure of 10⁻¹²⁻¹³ atm is no longer an electrical insulator. The BaTiO₃ specimen can not be applied as ceramic capacitor as it is sintered in an atmosphere of low oxygen partial pressure.

### EXAMPLE 4

In the present example, the effect of metallic nickel particles on the electrical properties of BaTiO₃ is demonstrated. Various amounts of nickel are mixed with barium titanate powder. Then various heat treatment and sintering steps were applied to the powder mixtures. The experimental detail and results are shown in the following.

(a) The barium titanate powder is the same as that used in the Example 1. The barium titanate powder is mixed with various amounts of nickel nitrate by turbo milling in a PE jar. The grinding media was zirconia balls and the solvent ethyl alcohol. A slurry was formed after the milling process.
(b) The slurry was dried in a vacuum dryer. The partial dried powder is then dried in an oven at 100 C for 24 hours.
(c) The lumps were crushed with mortar and pestle, and then passed a #150 sieve. The powder was then calcined in an alumina crucible. The nickel nitrate was decomposed to result in nickel oxide at this stage, as confirmed by the XRD analysis. The calcinations treatment was carried out at 500 C for 1 hour. The heating rate and cooling rate were 1 C/min.
(d) The calcined powder was again crushed with mortar and pestle, and then passed a #150 sieve. The powder was then reduced in an alumina crucible at 800 C for 2 hours. The reduction atmosphere was 90% N₂/10% H₂, the oxygen partial pressure was 10⁻²⁰⁻²¹ atm. The heating rate and cooling rate were 3 C/min.

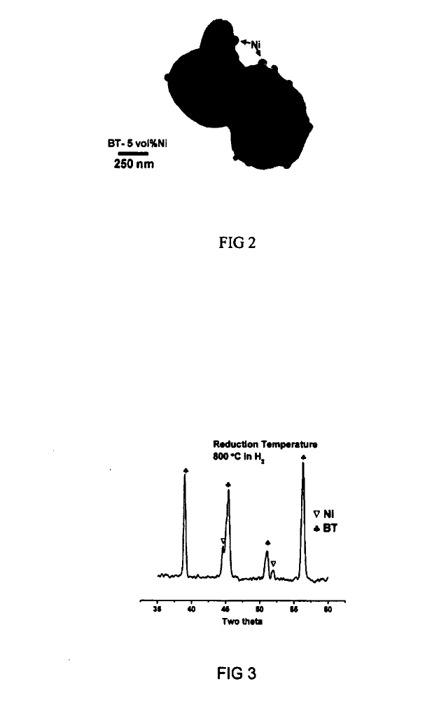

The X-ray diffraction technique (XRD) was used to analyze the phases after each treatment. The XRD analysis confirmed that that nickel nitrate is fully decomposed into nickel oxide after the thermal decomposition treatment. The nickel oxide is then reduced to result in metallic particles after the reduction treatment. The powder mixtures of BaTiO₃ and Ni are shown in FIG. 2. By comparing the TEM micrograph shown in FIG. 1, the fine nickel particles are found to locate on the surface of BaTiO₃ particles. The XRD analysis shows that only BaTiO₃ and Ni are present in the powder mixtures, it further confirms that the fine particles are nickel particles. The size of the fine Ni particles is around 0.07 micrometer.

### EXAMPLE 5

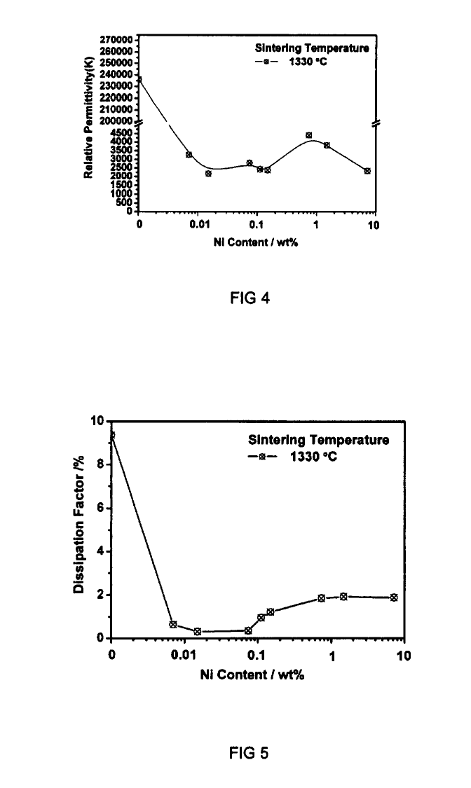

The BaTiO₃/Ni composite powders as prepared with the same procedures demonstrated in the Example 4. The amount of the metallic Ni particles varies from 0.1 to 8.0 wt %. The powder mixtures were formed into discs (diameter of 10 mm) by uniaxial pressing at 20 MPa. The discs were sintered at 1330 C for 2 hours in an atmosphere of commercial nitrogen. The oxygen partial pressure in the commercial nitrogen at the sintering temperature was 10⁻⁴⁻⁵ atm as determined by a zirconia oxygen sensor which located above the discs. The heating and cooling rates were 3 C/min. A silver paste was applied onto the surfaces of the discs, and then fired at 600 C for 1 hour. The heating and the cooling rates were 5 C/min. The electrical properties of the discs were then measured. These properties are shown in FIGS. 4, 5 and 6.

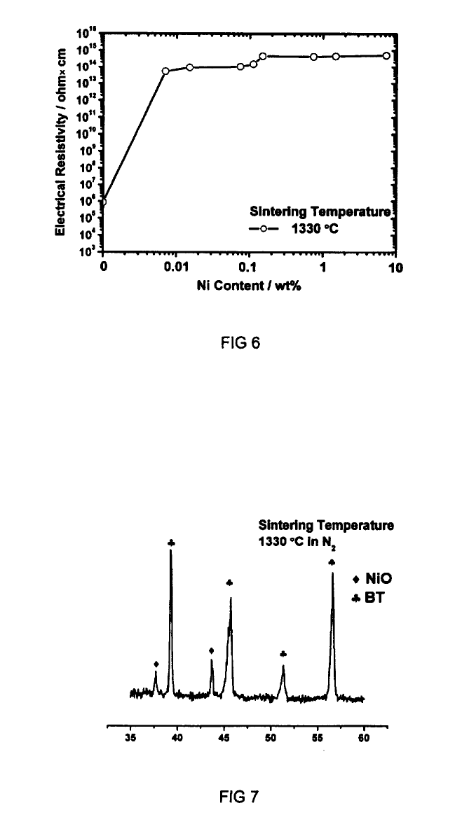

FIG. 3 shows that the XRD pattern of the powder after reduction at 800 C for 2 hours in 90% N₂/10% H₂. The figure demonstrates that the metallic nickel and BaTiO₃ are the only phases in the powder mixtures. The amount of the Ni is 10 wt %. After sintering in commercial nitrogen, the nickel is oxidized to result in nickel oxide, as demonstrated in the XRD pattern shown in FIG. 7. It indicates that the metallic nickel can absorb oxygen from the atmosphere. The equilibrium oxygen partial pressure of the oxidation of nickel to result in nickel oxide is 10⁻⁹ atm. As long as the oxidation of nickel is taken place, the oxygen partial pressure within the BaTiO₃ system is 10⁻⁹ atm. In such environment, the inner nickel electrode is free from oxidation. Furthermore, part of the nickel oxide can dissolve into barium titanate at elevated temperature. Due to the nickel ion acts as the acceptor to the barium titanate, the insulation resistance is enhanced due to the presence of nickel solute. The increase of the electrical resistance by adding nickel is demonstrated in FIG. 6. The figure shows that the electrical resistance of the barium titanate is increased as nickel is added. Furthermore, the dissipation factor is decreased significantly, FIG. 5.

### EXAMPLE 6

(a) The barium titanate powder is the same as that used in the Example 1. The barium titanate powder is mixed with a small amount of nickel acetate by turbo milling in a PE jar. The grinding media was zirconia balls and the solvent ethyl alcohol. A slurry was formed after the milling process.
(b) The slurry was dried in a vacuum dryer. The dried powder is then dried in an oven at 100 C for 24 hours.
(c) The lumps were crushed with mortar and pestle, and then passed a #150 sieve. The powder was then calcined in an alumina crucible at 500 C for 1 hour. The nickel acetate was decomposed to result in nickel oxide at this stage, as confirmed by the XRD analysis. The heating rate and cooling rate were 1 C/min.
(d) The calcined powder was again crushed with mortar and pestle, and then passed a #150 sieve. The powder was then reduced in an alumina crucible at 800 C for 2 hours. The reduction atmosphere was 90% N₂/10% H₂, the oxygen partial pressure was 10⁻²⁰⁻²¹ atm. The heating rate and cooling rate were 3 C/min. The X-ray diffraction technique (XRD) was used to analyze the phases after each treatment. The XRD confirms that the metallic nickel is resulted after the reduction treatment. The final amount of nickel is 1.4 wt %.
(e) The powder mixtures were formed into discs (diameter of 10 mm) by uniaxial pressing at 20 MPa.
(f) The discs were sintered at 1330 C for 2 hours in an atmosphere of commercial nitrogen. The oxygen partial pressure in the commercial nitrogen at the sintering temperature was 10⁻⁴⁻⁵ atm as determined by a zirconia oxygen sensor which located above the discs. The heating and cooling rates were 3 C/min.
(g) A silver paste was applied onto the surfaces of the discs, and then fired at 600 C for 1 hour. The heating and the cooling rates were 5 C/min. The electrical properties of the discs were then measured. The dielectric constant of the discs is 560, the electrical resistivity 6.0×10¹² ohm-cm.

The present example demonstrates that nickel acetate can also be used as the starting material for nickel. The powder mixtures of ceramic dielectric and fine metallic nickel are suitable for the dielectric of BME-MLCC.

### EXAMPLE 7

(a) The barium titanate powder is the same as that used in the Example 1. The barium titanate powder is mixed with a small amount of nickel nitrate by turbo milling in a PE jar for 4 hours. The grinding media was zirconia balls and the solvent ethyl alcohol. A slurry was prepared after the milling process.
(b) The slurry was dried in a vacuum dryer. The partial dried powder is then dried in an oven a 100 C for 24 hours.
(c) The dried lumps were crushed with mortar and pestle, and then passed a #150 sieve. The powder was then calcined in an alumina crucible. The nickel nitrate was decomposed to result in nickel oxide. The calcinations treatment was carried out at 500 C for 1 hour. The heating rate and cooling rate were 1 C/min.
(d) The calcined powder was again crushed with mortar and pestle, and then passed a #150 sieve. The powder was then reduced in an alumina crucible at 800 C for 2 hour. The reduction atmosphere was 90% N₂/10% H₂, the oxygen partial pressure was 10⁻²⁰⁻²¹ atm. The heating rate and cooling rate were 3 C/min. The X-ray diffraction technique (XRD) was used to analyze the phases after each treatment. The XRD confirms that the metallic nickel is resulted after the reduction treatment. The final amount of nickel is 1.4 wt %.
(e) The powder mixtures were formed into discs (diameter of 10 mm) by uniaxial pressing at 20 MPa.
(f) The discs were sintered at 1330 C for 2 hours in the atmospheres with various oxygen partial pressure. The oxygen partial pressure in the sintering atmospheres as determined by a zirconia oxygen sensor is 0.20□10⁻⁴⁻⁵□10⁻⁷⁻⁸□10⁻¹⁰⁻¹² and 10⁻¹²⁻¹³ atm. The heating and cooling rates were 3 C/min.
(g) A silver paste was applied onto the surfaces of the discs, and then fired at 600 C for 1 hour. The heating and the cooling rates were 5 C/min. The electrical properties of the discs sintered in various sintering atmosphere are shown in Table 1.

The data shown in Table 1 demonstrated that the nickel containing dielectrics can be used as the dielectric for ceramic capacitor as they are sintered in an oxygen partial pressure above 10⁻⁹ atm.

TABLE 1
The electrical properties of the nickel containing dielectrics
after sintering in various oxygen partial pressures.

| oxygen partial | electrical | | |
|---|---|---|---|
| pressure/ | resistivity/ | dielectric | |
| atm | ohm cm | constant | dielectric loss % |
| 0.2 | 2.1 × 10¹⁴ | 1800 | 2.6 |
| 10^{-4–5} | 4.8 × 10¹³ | 3800 | 1.9 |
| 10^{-7–8} | 2.8 × 10¹³ | 4400 | 2.0 |
| 10^{-10–12} | 6.0 × 10⁴ | 117000 | 80 |
| 10^{-12–13} | 3.8 × 10³ | 286000 | 142 |

### EXAMPLE 8

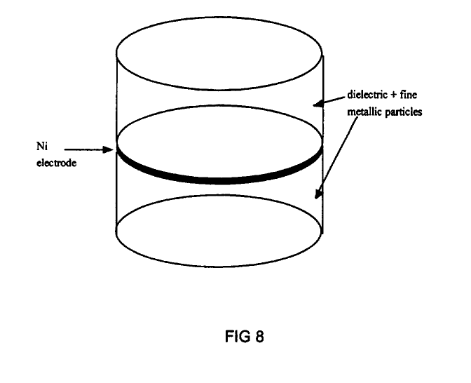

The nickel-containing dielectric, as that used in the Example 4, was used in the present Example. The nickel-containing dielectric powder was formed into discs by uniaxial pressing at 20 MPa. The diameter of the disc was 10 mm. A commercial nickel paste (NLP-78645, Sumitomo Metal Mining Co. Ltd., Japan) used for BME-MLCC was applied onto one surface of the disc. Another disc with the same composition was then attached to the first disc to form a sandwich structure, as shown in the schematic of FIG. 8. The sandwiched specimens were then sintered at 1330 C for 2 hours in commercial nitrogen. The oxygen partial pressure of the commercial nitrogen was 10⁻⁴⁻⁵ atm. The heating and cooling rates were 3 C/min. After sintering, the electrical resistance of the nickel electrode is low, indicating that the Ni electrode remains electrical conducting. It confirms that the metal-containing dielectric disclosed in the present invention can be used as the dielectric of BME-MLCC.

### EXAMPLE 9

In the present example, various amounts of nickel powder are mixed with barium titanate powder. Then heat treatments were applied to the powder mixtures. The experimental detail and results are shown in the following.

(a) The barium titanate powder is the same as that used in the Example 1. The barium titanate powder is mixed with various amounts of nickel powder by turbo milling in a PE jar. The grinding media was zirconia balls and the solvent ethyl alcohol. A slurry was formed after the milling process.
(b) The slurry was dried in a vacuum dryer. The partial dried powder is then dried in an oven at 100 C for 24 hours.
(c) The lumps were crushed with mortar and pestle, and then passed a #150 sieve.

The powder mixtures of BaTiO₃ and various amount of Ni were examined. By comparing the TEM micrograph confirms that the fine nickel particles are found to locate on the surface of BaTiO₃ particles.

### EXAMPLE 10

The BaTiO₃/Ni composite powders as prepared with the same procedures demonstrated in the Example 9. The amount of the metallic Ni particles varies from 0.007 to 7.2 wt %. The powder mixtures were formed into discs (diameter of 10 mm) by uniaxial pressing at 20 MPa. The discs were sintered at 1330 C for 2 hours in an atmosphere of commercial nitrogen. The oxygen partial pressure in the commercial nitrogen at the sintering temperature was 10⁻⁴⁻⁵ atm as determined by a zirconia oxygen sensor which located above the discs. The heating and cooling rates were 3 C/min. A silver paste was applied onto the surfaces of the discs, and then fired at 600 C for 1 hour. The heating and the cooling rates were 5 C/min. The electrical properties of the discs were then measured. These data of electrical properties are shown in Table 2.

TABLE 2
The electrical properties of dielectrics containing
various amount of nickel after sintering in an
atmosphere of commercial nitrogen.

| | | | Electrical |
|---|---|---|---|
| Starting composition/ | Dielectric | Dissipation | resistivity/ |
| wt % | constant | factor/% | ohm-cm |
| BaTiO₃ | 23500 | 9.4 | 9 * 10⁵ |
| BaTiO₃ + 0.007 wt % Ni | 3300 | 0.64 | 5 * 10¹³ |
| BaTiO₃ + 0.015 wt % Ni | 2200 | 0.31 | 9 * 10¹³ |
| BaTiO₃ + 0.074 wt % Ni | 2800 | 0.35 | 1 * 10¹⁴ |
| BaTiO₃ + 0.11 wt % Ni | 2400 | 0.96 | 1 * 10¹⁴ |
| BaTiO₃ + 0.15 wt % Ni | 2400 | 1.2 | 4 * 10¹⁴ |
| BaTiO₃ + 0.74 wt % Ni | 4400 | 1.9 | 4 * 10¹⁴ |
| BaTiO₃ + 1.5 wt % Ni | 3800 | 1.9 | 5 * 10¹⁴ |
| BaTiO₃ + 7.2 wt % Ni | 2300 | 1.9 | 5 * 10¹⁴ |

### EXAMPLE 11

In the present example, the barium titanate powder is mixed with a small amount of nickel powder (average particle size of 1.1 micrometer).

(a) The barium titanate powder is the same as that used in the Example 1. The barium titanate powder is mixed with 1.0 vol % of nickel powder by turbo milling in a PE jar. The grinding media was zirconia balls and the solvent ethyl alcohol. A slurry was formed after the milling process.
(b) The slurry was dried in a vacuum dryer. The dried powder is then dried in an oven at 100 C for 24 hours.
(c) The dried powder was crushed with mortar and pestle, and then passed a #150 sieve.
(d) The powder mixtures were formed into discs (diameter of 10 mm) by uniaxial pressing at 20 MPa.
(e) The discs were sintered at 1330 C for 2 hours in an atmosphere of oxygen partial pressure at 10⁻⁴⁻⁵ atm. The heating and cooling rates were 3 C/min.
(f) A silver paste was applied onto the surfaces of the discs.
(g) Then fired at 600 C for 1 hour. The heating and the cooling rates were 5 C/min.
(h) The electrical properties of the discs were then measured.

### EXAMPLE 12

In the present example, the barium titanate powder is mixed with a small amount of titanium powder (passed a #325 sieve).

(a) The barium titanate powder is the same as that used in the Example 1. The barium titanate powder is mixed with 1.0 vol % of titanium powder by turbo milling in a PE jar. The grinding media was zirconia balls and the solvent ethyl alcohol. A slurry was formed after the milling process.
(b) The slurry was dried in a vacuum dryer. The dried powder is then dried in an oven at 10° C. for 24 hours.
(c) The dried powder was crushed with mortar and pestle, and then passed a #150 sieve.
(d) The powder mixtures were formed into discs (diameter of 10 mm) by uniaxial pressing at 20 MPa.
(e) The discs were sintered at 1330 C for 2 hours in an atmosphere of oxygen partial pressure at 10⁻⁴⁻⁵ atm. The heating and cooling rates were 3 C/min.
(f) A silver paste was applied onto the surfaces of the discs.
(g) Then fired at 600 C for 1 hour. The heating and the cooling rates were 5 C/min.
(h) The electrical properties of the discs were then measured.

### EXAMPLE 13

In the present example, the barium titanate powder is mixed with a small amount of manganese powder (passed a #325 sieve).

(a) The barium titanate powder is the same as that used in the Example 1. The barium titanate powder is mixed with 1.0 vol % of manganese powder by turbo milling in a PE jar. The grinding media was zirconia balls and the solvent ethyl alcohol. A slurry was formed after the milling process.
(b) The slurry was dried in a vacuum dryer. The dried powder is then dried in an oven at 10° C. for 24 hours.
(c) The dried powder was crushed with mortar and pestle, and then passed a #150 sieve.
(d) The powder mixtures were formed into discs (diameter of 10 mm) by uniaxial pressing at 20 MPa.
(e) The discs were sintered at 1330 C for 2 hours in an atmosphere of oxygen partial pressure at 10⁻⁴⁻⁵ atm. The heating and cooling rates were 3 C/min.
(f) A silver paste was applied onto the surfaces of the discs.
(g) Then fired at 600 C for 1 hour. The heating and the cooling rates were 5 C/min.
(h) The electrical properties of the discs were then measured.

### EXAMPLE 14

In the present example, various amounts of nickel are mixed with barium titanate powder. Then various heat treatment and sintering step were applied to the powder mixtures. The experimental detail and results are shown in the following.

(a) The barium titanate powder is the same as that used in the Example 1. The barium titanate powder is mixed with various amounts of nickel nitrate by turbo milling in a PE jar. The grinding media was zirconia balls and the solvent ethyl alcohol. A slurry was formed after the milling process.
(b) The slurry was dried in a vacuum dryer. The partial dried powder is then dried in an oven at 10° C. for 24 hours.
(c) The lumps were crushed with mortar and pestle, and then passed a #150 sieve. The powder was then calcined in an alumina crucible. The nickel nitrate was decomposed to result in nickel oxide at this stage, as confirmed by the XRD analysis. The calcinations treatment was carried out at 500 C for 1 hour. The heating rate and cooling rate were 1 C/min.
(d) The calcined powder was again crushed with mortar and pestle, then passed a #150 sieve. The powder was then reduced in an alumina crucible at 800 C for 2 hour. The reduction atmosphere was 90% N₂/10% H₂, the oxygen partial pressure was 10⁻²⁰⁻²¹ atm. The heating rate and cooling rate were 3 C/min. The powder mixtures contained from 0.005 vol % to 50 vol % of nickel powder.
(e) The powder mixtures were formed into discs (diameter of 10 mm) by uniaxial pressing at 20 MPa.
(f) The discs were sintered at 1330 C for 2 hours in various oxygen partial pressure atmosphere. The oxygen partial pressure was 10⁻⁵ atm as determined by a zirconia oxygen sensor which located above the discs. The heating and cooling rates were 3 C/min.
(g) A silver paste was applied onto the surfaces of the discs, and then fired at 600 C for 1 hour. The heating and the cooling rates were 5 C/min. The electrical properties of the discs were then measured. The data of electrical properties are shown in Table 3.

TABLE 3
The electrical properties of the various amount of
nickel containing dielectrics after sintering in an
atmosphere of commercial nitrogen.

| | | | Electrical | |
|---|---|---|---|---|
| | Dielectric | Dissipation | resistivity/ | |
| Starting composition | constant | factor/% | ohm-cm | Note |
| BaTiO₃ | 23500 | 9.4 | 9 * 10⁵ | Ex 2 |
| BaTiO₃ + 0.005 vol % Ni | 3300 | 0.64 | 5 * 10¹³ | Ex 14 |
| BaTiO₃ + 0.01 vol % Ni | 2200 | 0.31 | 9 * 10¹³ | Ex 14 |
| BaTiO₃ + 0.05 vol % Ni | 2800 | 0.35 | 1 * 10¹⁴ | Ex 14 |
| BaTiO₃ + 0.075 vol % Ni | 2400 | 0.96 | 1 * 10¹⁴ | Ex 14 |
| BaTiO₃ + 0.1 vol % Ni | 2400 | 1.2 | 4 * 10¹⁴ | Ex 14 |
| BaTiO₃ + 0.5 vol % Ni | 4400 | 1.9 | 4 * 10¹⁴ | Ex 14 |
| BaTiO₃ + 1.0 vol % Ni | 3800 | 1.9 | 5 * 10¹⁴ | Ex 14 |
| BaTiO₃ + 5.0 vol % Ni | 2300 | 1.9 | 5 * 10¹⁴ | Ex 14 |
| BaTiO₃ + 35 vol % Ni | 28800 | 3.5 | 3 * 10¹² | Ex 14 |
| BaTiO₃ + 50 vol % Ni | — | >50 | 9 * 10⁶ | Ex 14 |

1. A ceramic dielectric for base-metal-electrode multilayered ceramic capacitors comprises ceramic dielectric powders and at least one chemical active metallic powder, wherein the chemical activity of the chemical active metallic powder to oxygen is not lower than that of the base-metal of the internal electrode to oxygen.

2. A ceramic dielectric according to claim 1, wherein the ceramic dielectric powder is selected from barium titanate powder, strontium titanate powder and zinc titanate powder.

3. A ceramic dielectric according to claim 1, wherein the ceramic dielectric powder is barium titanate powder.

4. A ceramic dielectric according to claim 1, wherein the ceramic dielectric powder is zinc titanate powder.

5. A ceramic dielectric according to claim 1, wherein the base-metal electrode contained nickel metallic powder.

6. A ceramic dielectric according to claim 1, wherein the base-metal electrode contained copper metallic powder.

7. A ceramic dielectric according to claim 1, wherein the chemical active metallic powder is selected from nickel fine powder, titanium fine powder, manganese fine powder, copper fine powder and mixture thereof.

8. A ceramic dielectric according to claim 1, wherein the chemical active metallic powder is nickel fine powder.

9. A ceramic dielectric according to claim 1, wherein the chemical active metallic powder is titanium fine powder.

10. A ceramic dielectric according to claim 1, wherein the chemical active metallic powder is manganese fine powder.

11. A ceramic dielectric according to claim 1, wherein the chemical active metallic powder is copper fine powder.

12. A ceramic dielectric according to claim 1, wherein the amount of the chemical active metallic powder is between 0.001 vol % and 50 vol %.

13. A ceramic dielectric according to claim 1, wherein the amount of the chemical active metallic powder is between 0.005 vol % and 35 vol %.

14. A ceramic dielectric according to claim 1, wherein the amount of the chemical active metallic powder is between 0.001 wt % and 10 wt %.

15. A ceramic dielectric according to claim 1, wherein the amount of the chemical active metallic fine powder is between 0.1 wt % and 5 wt %.

16. A ceramic dielectric according to claim 1, wherein the particle size of the chemical active metallic fine powder is smaller than that of the base-metal of the internal electrode.

17. A ceramic dielectric according to claim 1, wherein the particle size of the chemical active metallic powder is smaller than 100 micrometer.

18. A ceramic dielectric according to claim 1, wherein the particle size of the chemical active metallic powder is smaller than 10 micrometer.

19. A ceramic dielectric according to claim 1, wherein the particle size of the chemical active metallic powder is smaller than 0.6 micrometer.

20. A ceramic dielectric according to claim 1, wherein the ceramic dielectric powder further comprises rear-earth oxide powder.

21. A ceramic dielectric according to claim 1, wherein the ceramic dielectric powder not comprise any rear-earth oxide.

22. A method for preparation of ceramic dielectrics for base-metal-electrode multilayered ceramic capacitors, which is mixing at least one chemical active metallic powder to ceramic dielectric powders.

23. A method according to claim 22, wherein the chemical active metallic powder is selected from nickel fine powder, titanium fine powder, manganese fine powder, copper fine powder and mixture thereof.

24. A method according to claim 22, wherein the particle size of the chemical active metallic powder is smaller than 100 micrometer.

25. A method according to claim 22, wherein the particle size of the chemical active metallic powder is smaller than 10 micrometer.

26. A method according to claim 22, wherein the amount of the chemical active metallic powder is between 0.001 vol % and 50 vol %.

27. A method according to claim 22, wherein the amount of the chemical active metallic powder is between 0.005 vol % and 35 vol %.

28. A method for preparation of ceramic dielectrics for base-metal-electrode multilayered ceramic capacitors, which is started with the mixing a nickel salt solution with barium titanate based ceramic dielectric powder and then dried to remove the solvent and then calcined the powder mixture to decompose the nickel salt to result in nickel oxide, and then reduced the powder mixture in a reducing atmosphere to result in fine nickel particles and resulted fine nickel particles distribute uniformly within the barium titanate based particles.

29. A method for preparation of ceramic dielectrics for base-metal-electrode multilayered ceramic capacitors, comprising following steps,
(a) A nickel salt is dissolved in a solvent or water to form a solution;
(b) The ceramic dielectric powder is then added slowly into said solution and formed slurry. The slurry is then ball milled for several hours;
(c) The slurry is then dried to remove the solvent. The dried lumps are then crushed to result in powder mixture;
(d) The powder mixture is calcined at an elevated temperature to thermal decompose the nickel salts. The nickel metal can also be oxidized to form nickel oxide; and
(e) The calcined powder mixture is then reduced in a reducing atmosphere to reduce the nickel oxide to result in nickel;
wherein the nickel metal particles are existed uniformly within the ceramic dielectric particles.

30. A method according to claim 28 and claim 29, wherein the ceramic dielectric powder is barium titanate powder or zinc titanate powder.

31. A method according to claim 28, wherein the nickel salts is selected from nickel nitrate, nickel carbonate, nickel hydroxide, nickel citrate and nickel acetic.

32. A method according to claim 28, wherein the nickel salt is nickel nitrate.

33. A method according to claim 28, wherein the reducing atmosphere is 90% N₂/10% H₂

34. A method according to claim 28, wherein the amount of nickel fine powder is between 0.001 wt % and 10 wt %.

35. A method according to claim 28, wherein the amount of nickel fine powder is between 0.1 wt % and 5 wt %.

36. A method according to claim 28, wherein the particle size of nickel fine powder is smaller than 0.6 micrometer.

37. A base-metal-electrode multilayered ceramic capacitors, which is produced by co-firing the ceramic dielectric according to claim 1 with base-metal inner electrode.

38. A base-metal-electrode multilayered ceramic capacitors according to claim 37, wherein the base-metal inner electrode contained nickel metallic powder.

39. A base-metal-electrode multilayered ceramic capacitors according to claim 37, wherein the base-metal inner electrode contained copper metallic powder.

40. A base-metal-electrode multilayered ceramic capacitors according to claim 37, wherein the co-firing is in an atmosphere of above 10⁻⁹ atm oxygen partial pressure.

41. A base-metal-electrode multilayered ceramic capacitors according to claim 37, wherein the co-firing is in an atmosphere of above 10⁻⁴ atm oxygen partial pressure.

42. A base-metal-electrode multilayered ceramic capacitors according to claim 37, wherein the co-firing is in an atmosphere of commercial nitrogen.

43. A base-metal-electrode multilayered ceramic capacitors according to claim 37, wherein the co-firing is in an atmosphere of air.
